(19) United States
(12) Patent Application Publication
(10) Pub. No.: US 2006/0149899 A1
(43) Pub. Date: Jul. 6, 2006

(54) Method and apparatus for ongoing block storage device management

(76) Inventors: Vincent J. Zimmer, Federal Way, WA (US); Michael A. Rothman, Puyallup, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,568

(22) Filed: Dec. 30, 2004

(51) Int. Cl. G06F 12/00

(52) U.S. Cl. 711/112

(57) ABSTRACT

Methods and apparatus for performing ongoing block storage device management operations. Software and/or firmware components are disclosed for performing ongoing block storage device management operations, such as file defragmentation and file erasures, in conjunction with corresponding block input/output (I/O) transactions for block storage devices, such as magnetic disk drives and optical drives. For example, in conjunction with performing a file update (block I/O write), file defragmentation operations are performed on the file. Similarly, block erase operations are performed in conjunction with deleting a file, so as to remove all data artifacts of the file at the same time it is deleted. Components for implementing the block storage device management operations may reside in an operating system layer, a firmware layer, or a virtualization layer.

### FIELD OF THE INVENTION

The field of invention relates generally to computer systems and, more specifically but not exclusively relates to techniques for performing ongoing block storage device management operations.

### BACKGROUND INFORMATION

Disk management concerns operations employed on magnetic disk drive (a.k.a. hard drives, disk drives, magnetic disks, etc.) to keep the disk drive and related file system healthy and operating in an efficient manner. Disk management typically involves operations initiated by users and/or an operating system (OS). For example, users can manage disks by deleting old files, temporary files that are left after an OS or application failure, rearrange file structures, etc. Meanwhile, the OS performs automatic removal of temporary files, various file utilities, etc.

Magnetic disks are the most common form of non-volatile data storage (e.g., a mass storage device). A typical large modern disk drive includes multiple disk platters on which the data are stored using a respective read/write head for each platter. Each platter is coated with a magnetic film containing very small iron particles. The disk drive enables mass quantities of data (a single modern disk drive may support storage of several hundred gigabytes) by magnetizing the iron particles so they are oriented in a manner that supports a binary storage scheme. During data writing, the polarity of the magnetic structure in the read/write head of the magnetic disk drive is rapidly changed as the platter spins to orient iron particles to form binary bit streams.

In order to support a viable storage scheme, the storage space must be partitioned in a logical manner. Thus, a disk is formatted in a manner that divides the disk radially into sectors and into concentric circles called tracks. One or more sectors on a single track make up a cluster or block. The number of bytes in a cluster varies according to the version of the operating system used to format the disk and the disk's size. A cluster or block is the minimum unit the operating system uses to stored information, regardless of the size of the underlying file.

From an operating system (OS) file system perspective, a disk drive appears as a large block storage device. The applications running on the (OS), as well as upper layers of the OS, don't care how the file system data is physically stored, leaving that task to the OS and firmware drivers and the underlying hardware (e.g., disk controllers and disk interfaces). Thus, there is a layer of abstraction between the operating system and the physical disk sub-system. The disk sub-system (i.e., disk and controller) stores data at physical locations on the disk (e.g., platter, track, sector). However, these physical locations are too specific for an OS that is designed to support disk drives of various sizes, types, and configurations. Thus, the controller (and/or firmware) makes the disk appear to the OS as a block storage device, wherein a given block is accessed via its corresponding logical block address (LBA).

An LBA-based device logically stores data in a sequence of numerically-ordered blocks. The number of blocks required to store a particular file is function of the relative size of the file and block size, with each file consuming at least one block. The operating system maintains a map of block usage, typically on a protected area of the disk. Under early versions of Microsoft operating systems (e.g., DOS), this map is called the FAT (file allocation table). Later Microsoft operating systems implement a virtual FAT (VFAT), which enhanced the basic FAT operations, but functions in similar manner. Operating systems such as Linux and Unix employ similar types of block use maps for their respective file systems.

When a file is first stored, the operating system looks for a contiguous sequence of free (e.g., unused) blocks that is large enough to store the entire file (whenever possible). The file data are then written to those blocks, and a corresponding entry is made in the (V)FAT that maps the location of the file to the blocks, and marks the type of use of the blocks (e.g., ready only, read/write, unused, hidden, archive, etc.). Over time, the number of free blocks decreases, and the length of the contiguous block sequences is greatly diminished. As a result, file fragmentation is required.

Under file fragmentation, data for a given file is written across a set of discontinuous blocks (i.e., there is at least one discontinuity in the block sequence). The (V)FAT entry now must include a chaining mechanism (e.g., a linked list) for identifying the start and end blocks associated with the discontinuities. This adds overhead and can dramatically slow down file transfer speeds.

In order to address problems associated with defragmentation, modern operating systems provide defragmentation programs. Although such programs are highly recommended, they are usually used infrequently, if at all. This is primarily due to the fact that defragmenting an entire disk may take several hours or longer (often 10+ hours). During the process, disk I/O (input/output) operations are so heavy that it effectively eliminates the availability of the system for other tasks.

Another common problem associated with disk drives is unerased files. Typically, a file is erased by simply marking its blocks as free blocks in the (V)FAT. While this enables these blocks to be used to store data for another file or files, it does nothing to remove the existing data (until being overwritten). As a result, the underlying data is still present on the disk, and can be read using special utility programs designed for such purposes. Even reformatting the drive may not erase all existing data blocks. As a result, erasing utilities have been developed. However, as with the aforementioned defragmentation programs, erasing utilities are very time consuming and used infrequently. Furthermore, since these utilities typically require separate purchase, they are not available to most users.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block diagram of a layered architecture employing an augmented operating system file system driver that performs ongoing block device management operations, according to one embodiment of the invention;

FIG. 2 is a flowchart illustrating operations and logic performed by one embodiment of the layered architecture of FIG. 1 to support ongoing block device management operations;

FIG. 2a is a flowchart illustrating operations and logic performed by one embodiment of the layered architecture of FIG. 9 to support ongoing block device management operations;

FIG. 3 is a flowchart illustrating operations and logic performed to determine which type of file defragmentation is to be performed in connection with the flowcharts of FIGS. 2 and 2a, according to one embodiment of the invention;

FIG. 4 is a flowchart illustrating operations and logic performed to defragment files, according to one embodiment of the invention;

FIG. 5 is a schematic diagram illustrating a file defragmentation sequence in accordance with the flowchart of FIG. 4, wherein the first block of the defragmented file is maintained;

FIG. 6 is a schematic diagram illustrating a file defragmentation sequence in accordance with the flowchart of FIG. 4, wherein the blocks of a defragmented file are moved to a free block space to defragment the file;

FIG. 7 is a block diagram of a layered architecture employing a firmware-based block I/O driver that performs ongoing block device management operations, according to one embodiment of the invention;

FIG. 8 is a flowchart illustrating operations performed in connection with maintaining synchrony between a block use map stored on a block store device and a corresponding block use map maintained in a memory cache by an operating system, according to one embodiment of the invention;

FIG. 9 is a block diagram of a layered architecture employing a virtualization layer that includes a I/O block driver that that performs ongoing block device management operations, according to one embodiment of the invention;

FIG. 10 is a table showing a portion of an exemplary boot record for a block storage device that is accessed by multiple operating systems; and

FIG. 11 is a schematic diagram of a system architecture that includes a multi-core processor having main and lightweight cores, wherein one or more of the lightweight cores are used to host an embedded file system accelerator that performs ongoing block device management operations, according to one embodiment of the invention.

### DETAILED DESCRIPTION

Embodiments of methods and apparatus for performing ongoing disk management operations are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

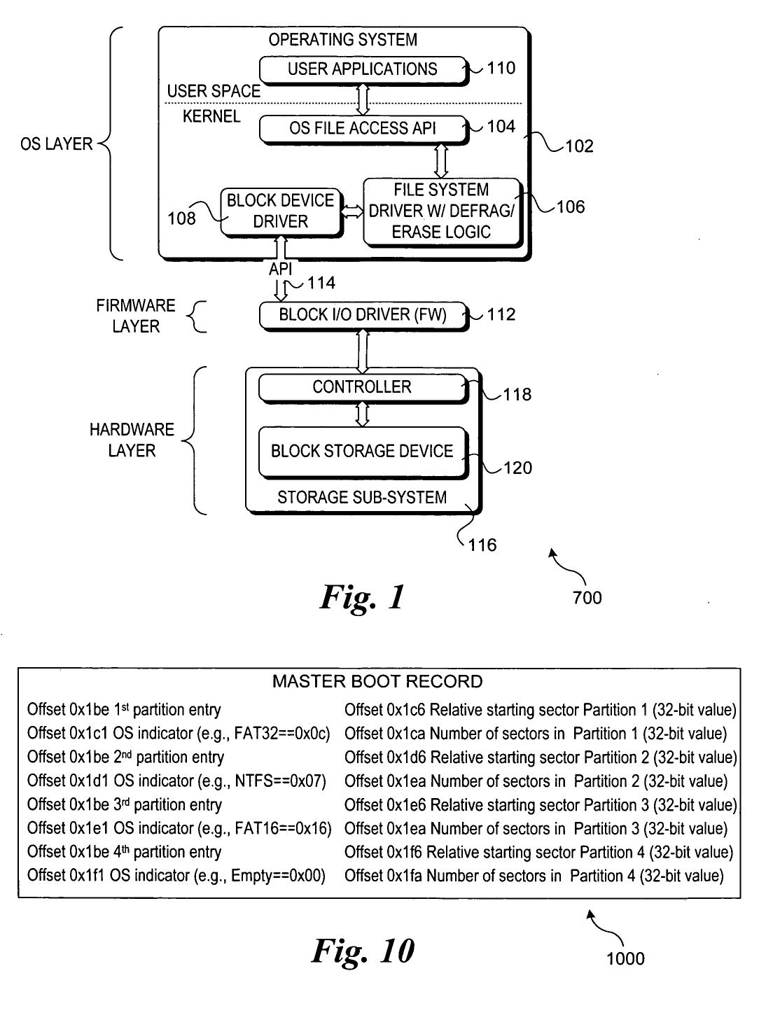

FIG. 1 shows an embodiment of a layered architecture 100 that supports ongoing disk management operations via the use of an augmented OS file system driver. The architecture includes an operating system layer, a firmware layer, and a hardware layer, as is the typical structure used for modern computer systems. The operating system layer includes an operating system 102, which is portioned into an OS kernel and user space. Various kernel components of operating system 102 are employed to support block storage device access, including an OS file access application program interface (API) 104, an augmented file system driver 106, and a block device driver 108. The augmented file system driver 106 includes built-in logic for performing ongoing block storage device management operations including file defragmentation and erase operations, as described below in further detail. These OS kernel components enable user applications 110 running in the user space of operating system 102 to request file system operations and perform appropriate actions in response to such request.

The firmware layer includes a firmware (FW) block I/O driver 112. This firmware driver interfaces with OS block device driver 108 via an OS-to-FW API 114. In general, the firmware layer provides an abstraction between underlying platform hardware and an operating system. In one embodiment, firmware block I/O driver comprises a conventional block I/O firmware driver.

The hardware layer includes a storage sub-system 116. The storage sub-system 116 is illustrative of various types of storage sub-systems that employ block storage devices, including but not limited to magnetic disk drives and optical drives. Typically, a storage sub-system will include a controller 118 that is used to drive a block storage device 120 of a similar type. For example, a disk drive will be driven by an appropriate disk drive controller, an optical drive will be driven by an appropriate optical drive controller, etc. The particular type of controller will also match the drive type. For instance, a SCSI (small computer system interface) disk drive will employ a SCSI controller, and IDE (integrated drive electronics) disk drive will employ an IDE controller, etc. As used herein, controller 116 is illustrative of controller elements that may be present on the drive itself (i.e., built-in controller electronics) and controller elements that are part of a separate component (e.g., a controller built into a platform chipset, or a controller provided by a peripheral add-on card).

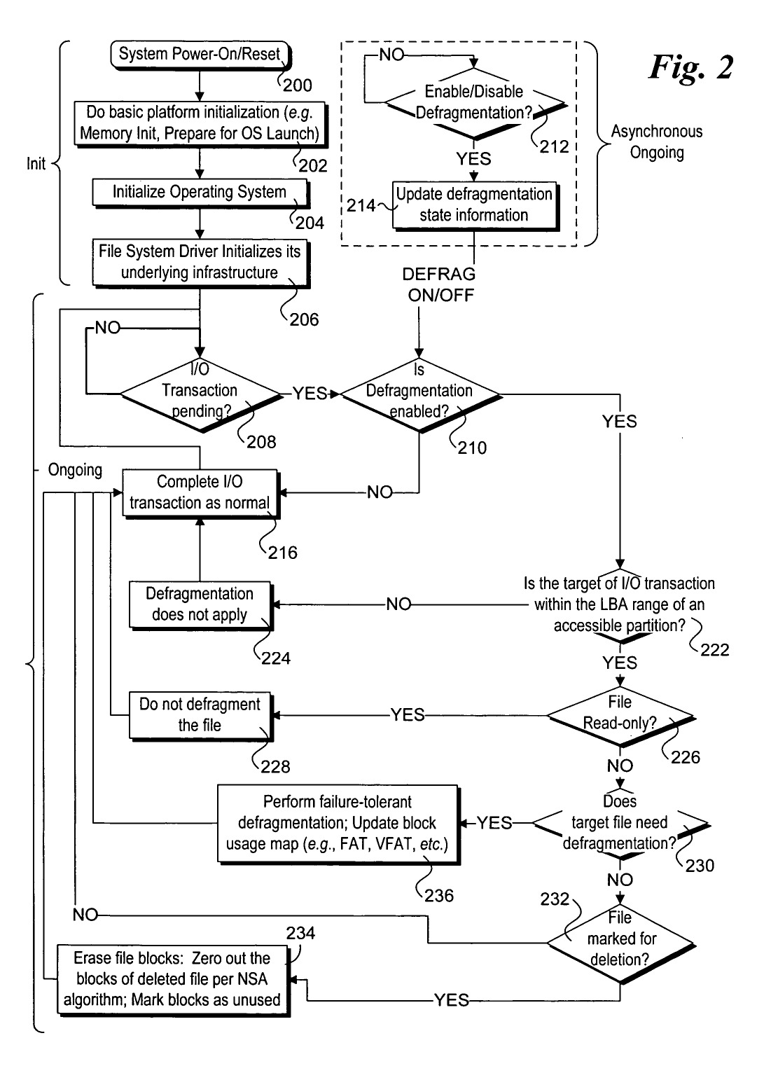

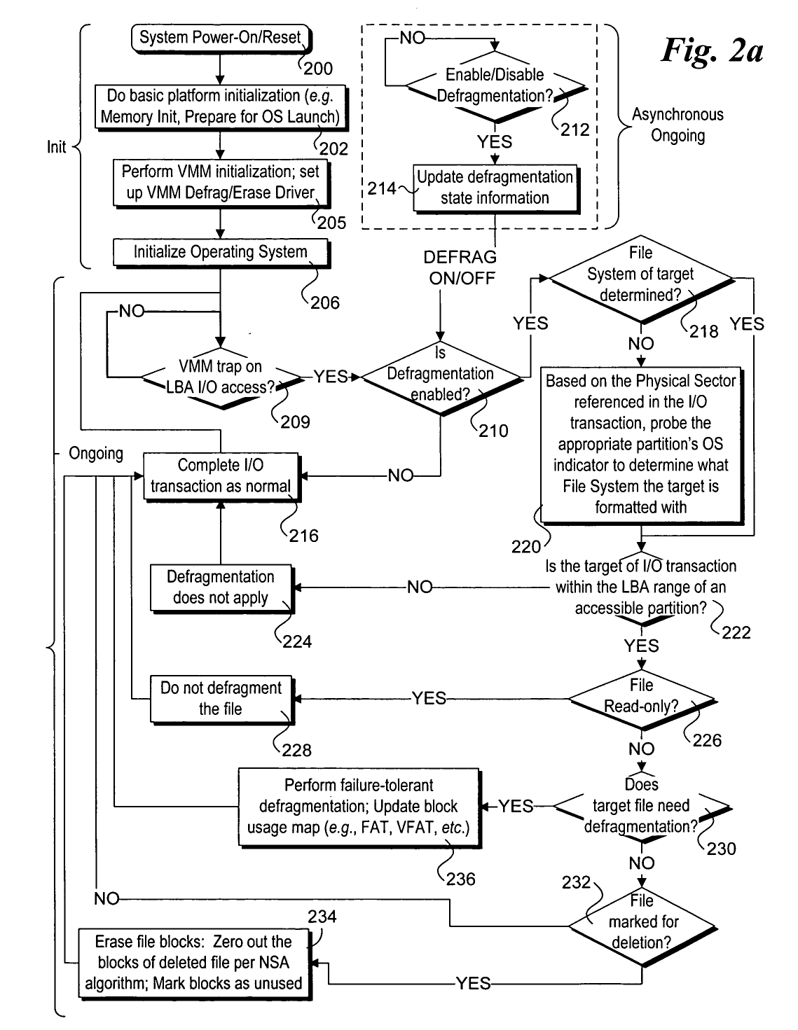

FIG. 2 shows a flowchart illustrating operations and logic performed in connection with ongoing block storage device management operations under one implementation of layered architecture 100. The process begins with a system power-on or reset event, as depicted by a start block 200. In response, the platform performs an init(ialization) phase, which begins by performing basic initialization operations in a block 202, such as memory initialization and preparing for the OS launch. The OS is then initialized (i.e., booted) in a block 204. During the OS initialization process, the augmented file system driver 106 initializes its underlying infrastructure in a block 206.

The remaining operations and logic pertain to ongoing OS runtime activities. As depicted by a decision block 208, these operations are performed in response to a pending block I/O transaction. Upon detection of a pending block I/O transaction, the logic proceeds to a decision block 210, wherein a determination is made to whether defragmentation is enabled.

In one embodiment, a defragmentation option can be turned on and off by a user, management agent, or built-in OS component. A change in the defragmentation option is detected by a decision block210. In response to this defragmentation option change, defragmentation state information is undated in a block 212, which has the effect of changing the defragmentation enabled/disabled condition used to evaluate decision block 210.

Continuing at decision block 210, if defragmentation is not enabled, the logic proceeds directly to complete the I/O transaction in the normal manner, as depicted by a block 216. For example, under layered architecture 100, augmented OS file system driver 106 would function as a conventional OS file system driver.

If defragmentation is enabled, the logic proceeds to a decision block 222, wherein a determination is made to whether the target of the I/O transaction is within the LBA range of a partition for which access is allowed. For example, some I/O transactions requests may pertain to data that are located in a partition that is not allowed to be accessed for general-purpose storage and the like (e.g., a protected partition). Thus, data written to these blocks should not be defragmented by augmented OS file system driver 106. Accordingly, defragmentation does not apply to these transactions, as depicted by a block 224, and the I/O transaction is completed in the normal manner in block 216.

If the I/O transaction is within the LBA range of an accessible partition, the logic proceeds to a decision block 226, wherein a determination is made to whether the file is read-only. In some cases, read-only files pertain to files that are reserved to be stored at known locations and/or in a pre-determined order. Accordingly, such files should not be defragmented, as depicted by a block 228. Thus, the logic proceeds to block 216 to complete the I/O transaction in the normal manner. Similar logic may apply to hidden files (not shown).

If the file is not read-only (or otherwise determined to be a non-protected file), a determination is made in a decision block 230 to whether the target file needs defragmentation. Details of this determination are discussed below. If no defragmentation is required, the logic proceeds to a decision block 232, wherein a determination is made to whether the file is marked for deletion. If not, the logic proceeds to block 216 to complete the I/O transaction in the normal manner. If the file is marked for deletion, the logic proceeds to a block 234 to erase the file. In one embodiment, that data on each block corresponding to the file are zeroed out using an NSA (National Security Administration) algorithm meeting the guidelines proscribed in the NSA CSS-130-2 “Media Declassification and Destruction Manual.” During this process, the blocks are overwritten multiple times using alternating patterns in order to remove any of the residual data artifacts in the blocks. The deletion process is then completed in block 216

Returning to decision block 230, if defragmentation is needed, a fault-tolerant defragmentation process, as described below, is performed in a block 232. Upon completion, the block use map employed for the corresponding operating system (e.g., FAT, VFAT, etc.) is updated to reflect the new block used for the file. The I/O transaction is then completed in block 216.

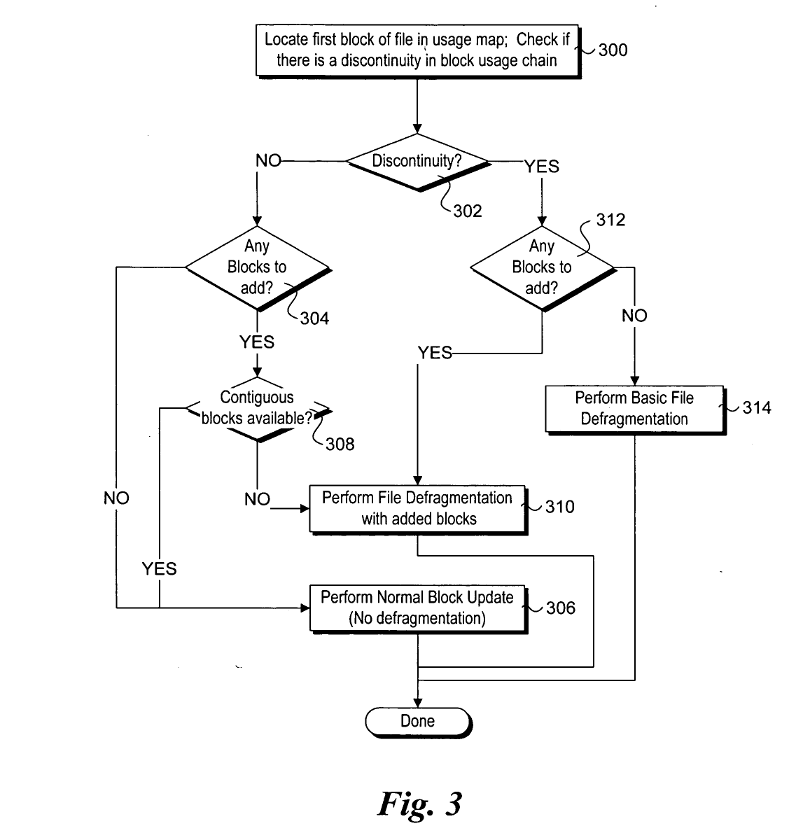

FIG. 3 shows a flowchart illustrating operations and logic performed during one embodiment to determine if defragmentation for a given file is required, and if so, what type of defragmentation is to be performed. The process begins in a block 300, wherein the first block of the file being modified (the target file) is located in the block use map (e.g., FAT, VFAT, etc.). A check is then made to determine if there are any discontinuities in the block usage chain for the file. This can be readily identified by the existence of more than one entry for the file.

In a decision block 302, a determination is made to whether any discontinuities exist. If the answer is NO, the current version of the file is stored as a contiguous set of blocks, meaning it is currently not fragmented, and thus requires no defragmentation. However, defragmentation operations may still be necessary if the file is to be increased in size, requiring extra blocks to store the file. Accordingly, a determination is made in a decision block 304 to whether there are any blocks that need to be added. If the answer is NO, the logic proceeds to a block 306 in which normal block update operations are performed.

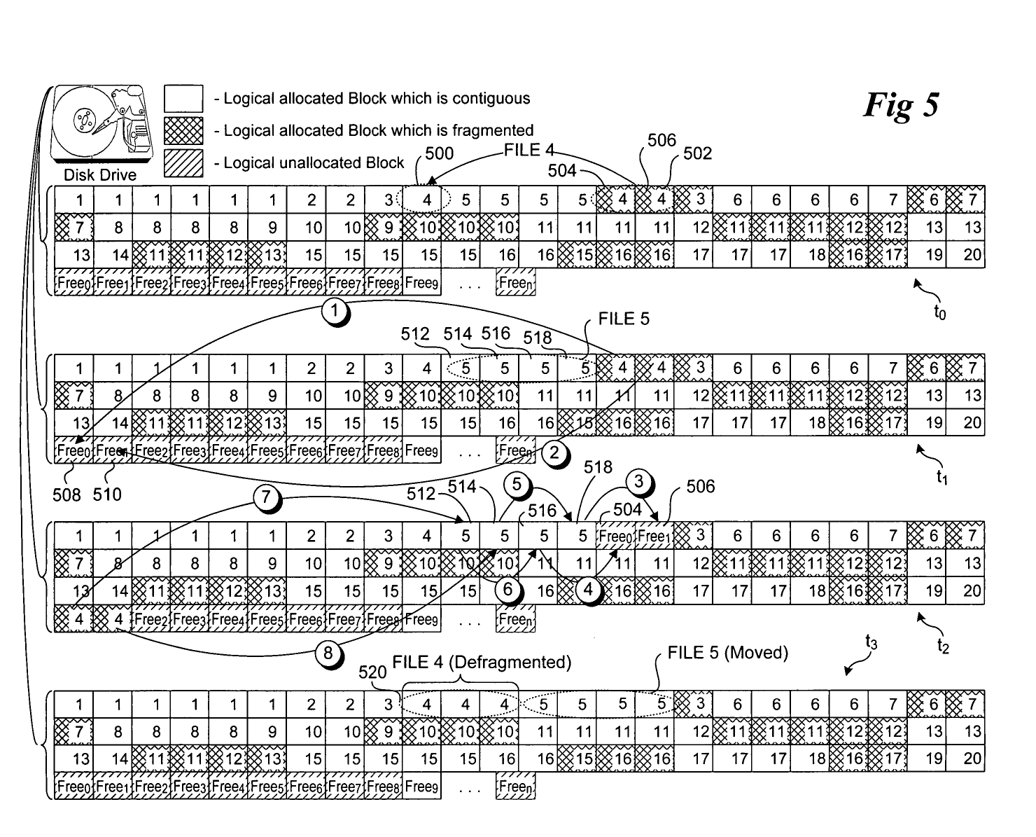

If there are blocks to add, the logic proceeds to a decision block 308, in which a determination is made to whether there are enough contiguous free blocks at the end of the current file (e.g., the last block of the current file) to add the one or more additional blocks that are needed to store the larger file. If there are enough blocks, the logic proceeds to block 306 to perform a normal block update, wherein the additional file data is added to the additional blocks. For example, in the exemplary block usage diagram of FIG. 5 (discussed below), there are n free blocks at the end of file 20. Accordingly, up to n blocks may be added to file 20 without requiring any defragmentation operations to be performed. In contrast, adding blocks to any of files 1-19 will require some level of defragmentation to be performed. This corresponds to a NO result for decision block 308, resulting in performing file defragmentation with added blocks operations in a block 310.

If discontinuities exist in the original file, as determined in decision block 302 as discussed above, the logic proceeds to a decision block 312 to determine whether any additional blocks need to be added to store the updated file. If the answer is YES, the logic proceeds to block 310 to perform the file defragmentation with added blocks operations. If there are no additional blocks to add, basic file defragmentation operations are performed in a block 314.

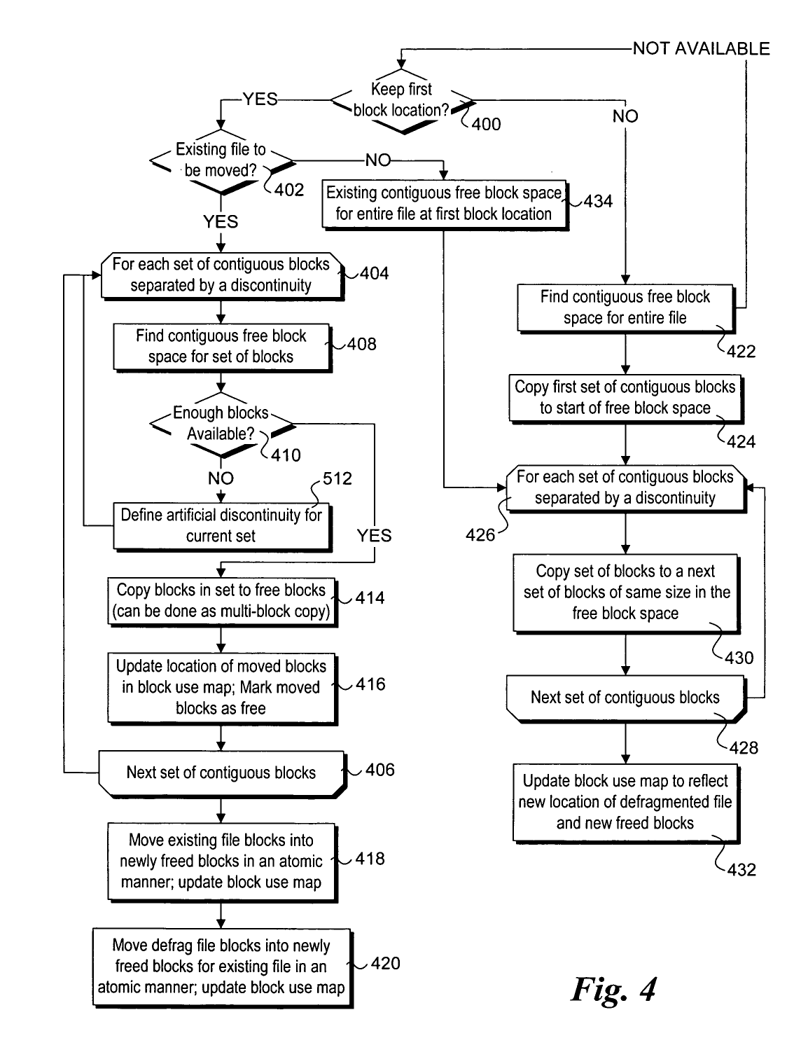

Operations and logic for performing one embodiment of a fault-tolerant basic file defragmentation process are illustrated in the flowchart of FIG. 4. The process begins at a block 400, wherein a determination is made to whether the location of the first block of the file is to be kept. In one embodiment described below, a given OS file system driver need only keep track of the location of the first block for each file. There may also be other reasons for keeping the first block in its existing location. In still other embodiments, it will be advantageous to move the first block under appropriate circumstances.

If the first block location is to be kept, the logic proceeds to a decision block 402 to determine if an existing file needs to be moved. For example, in the exemplary defragmentation sequence depicted in FIG. 5, File 4 is to be defragmentated. In order to defragment File 4 in the manner illustrated, it is necessary to move File 5. Thus, the answer to decision block 402 will be YES.

In response to a YES result for decision block 402, the operations depicted below this block are performed in the following manner. As depicted by start and end loop blocks 404 and 406, the operations depicted for inner loop blocks 408, 410, 412, 414, and 416 are performed in a looping manner for each set of contiguous blocks separated by a discontinuity. For instance, in the exemplary file defragmentation sequence of FIG. 5, File 4 initially includes a single file start block 600 and a single set 602 of contiguous blocks 604 and 606 separated by a discontinuity. In other instances, there might be two or more sets of blocks with discontinuities, with each set including at least one block.

In block 408, continuous block space for the current set of blocks being processed by the loop is found. In the example of FIG. 5, there are two blocks that need to be found, which are depicted as free blocks 608 and 610 for timeframes t₀ (the initial condition) and t₁ (the timeframe during which the first block copy operation of block 414 is performed). In some cases, the number of contiguous blocks in the current set will exceed the number of free contiguous blocks (e.g., the number of contiguous blocks required is >n in the example of FIG. 5). If this is the case, the answer to decision block 410 is NO, and an artificial discontinuity is defined for the current set (e.g., breaking the current set of continuous blocks into two halves), and the processing is returned to start loop block 404 to process the first of the two sets.

If enough contiguous blocks are available, the logic proceeds to block 414, wherein the blocks in the current set are copied into a corresponding number of free blocks. This may be performed using a multiple-block copy process and still support fault tolerance, since an existing set of blocks will always exist throughout the copy process. Optionally, the blocks may be copied on an individual basis.

After the blocks are copied, the location of these blocks (which are to comprise moved blocks) is updated in the block use map, as depicted in block 416. The previous blocks used to store the moved data (the blocks that were copied) are then marked as free. If necessary, the process loops block to start loop block 404 to process the next set of contiguous blocks.

Once all of the data corresponding to the discontinuous sets of blocks has been moved, existing file blocks are moved into the newly freed blocks in an atomic manner in a block 418, and the block use map is updated to reflect the move. The defragmented file blocks that were previously moved into free block space are then moved into the newly freed block space vacated by the existing file data that was moved, and the block use map is updated accordingly, as depicted in a block 420. As before, this is to be performed in an atomic manner, such that there always exists at least one copy of a given block throughout the move, and the block use map is always correct.

The foregoing sequence of operations depicted in FIG. 4 are graphically illustrated in the timeline sequence of FIG. 5. As discussed above, the goal is to defragment File 4, which will require moving File 5 (an existing file). In block 408, a free block space (blocks 608 and 610) for moving the contiguous portion of File 4 from blocks 604 and 606 of are found. At operations 1 and 2 (depicted by corresponding encircled numbers), the data in block 604 is copied into block 608, and the data in block 606 are copied into block 610. As depicted at timeframe t₂, this frees blocks 604 and 606. Since this is the only set of contiguous blocks separated by a discontinuity for File 4, the operations defined by start and loop blocks 404 and 406 are complete.

Next, the operations of block 418 are performed. This entails moving the data for existing File 5 in an atomic manner, wherein a fault at any point in time during the move process can be recovered. Initially, the data contents for File 5 are stored in blocks 512, 514, 516, and 518. The data for File 5 is then moved in the following manner. First, at operation 3, data in block 518 is moved to block 606, thus freeing block 518 (upon update of the block use map to reflect the move). Next, at operation 4, data in block 516 is moved to block 504. At operation 5, data in a block 514 is moved to newly vacated block 518, while data in block 512 is moved to newly vacated block 516 at operation 6. This completes the move of existing file 5, as depicted at timeframe t₃.

Now, the remaining operations of block 420 are performed. This entails moving the data in block 508 into block 512 at operation 7, and moving the data in block 510 to block 514 at operation 8. Upon update of the block use map to reflect the new location 520 of the File 4 blocks, the process is complete, as depicted by a contiguous File 4 shown at timeframe t₃ in FIG. 5.

Returning to decision block 400 of FIG. 4, it generally may be advantageous to allow the first block of the file to be defragmented to be moved. For example, in the example depicted in FIG. 6, suppose that the data in block 500 may be moved (thus moving the location of the first block of File 4). Accordingly, the logic proceeds to a block 422, wherein contiguous free block space for the entire file is found. It is noted that the determination made in decision block 400 and the operation of block 422 may be performed in conjunction with one another. For instance, if there is no contiguous block space to store an entire file (to be defragmented), the result of decision block 400 might be to simply keep the location of the first block and proceed with the defragmentation process shown on the left-hand side of FIG. 4 and discussed above.

In the example of FIG. 6, it is desired to defragment File 4, as before. File 4 includes requires three blocks of storage, and is currently stored in blocks 500, 504 and 506. Thus, three contiguous blocks of free space are searched for in block 422. These blocks comprise the target blocks for the defragmented file, and are depicted by free blocks 608, 610, and 612 in FIG. 6.

Once contiguous space is found (if applicable), the first set of contiguous blocks is copied to the start of the free block space in a block 424. This is schematically depicted in FIG. 6 at operation 1, which copies data from block 500 to block 608.

Next, as depicted by start and end loop blocks 426 and 428, the operations of block 430 are performed in a looping manner for each set of contiguous blocks separated by a discontinuity. This entails copying the current set of blocks to a next set of blocks of the same size in the free block space. Thus, in the example of FIG. 6, the data in the next (and last) set of contiguous blocks for File 4 (blocks 504 and 506) is copied into respective blocks 610 and 612 at operation 2. In general, the data in the blocks may be copied one at a time, or using a multi-block copy process.

After each applicable set of contiguous blocks is copied by the foregoing loop, the process is then completed in a block 432, wherein the block use map is updated to reflect the new location for the defragmented file and the location of any newly freed blocks.

Returning to decision block 402, in some instances there will be enough contiguous free block space immediately following the end of the first block or set of contiguous blocks for the file to be defragmented, as depicted by a block 434. Thus, in this instance, there will be no requirement to move an existing file. Accordingly, the operations of the loop defined by start and end loop blocks 426 and 428 are performed to defragment such files, with the result being the that entire file is reformed to be stored in a single contiguous set of blocks having the same starting block as the file had prior to defragmentation.

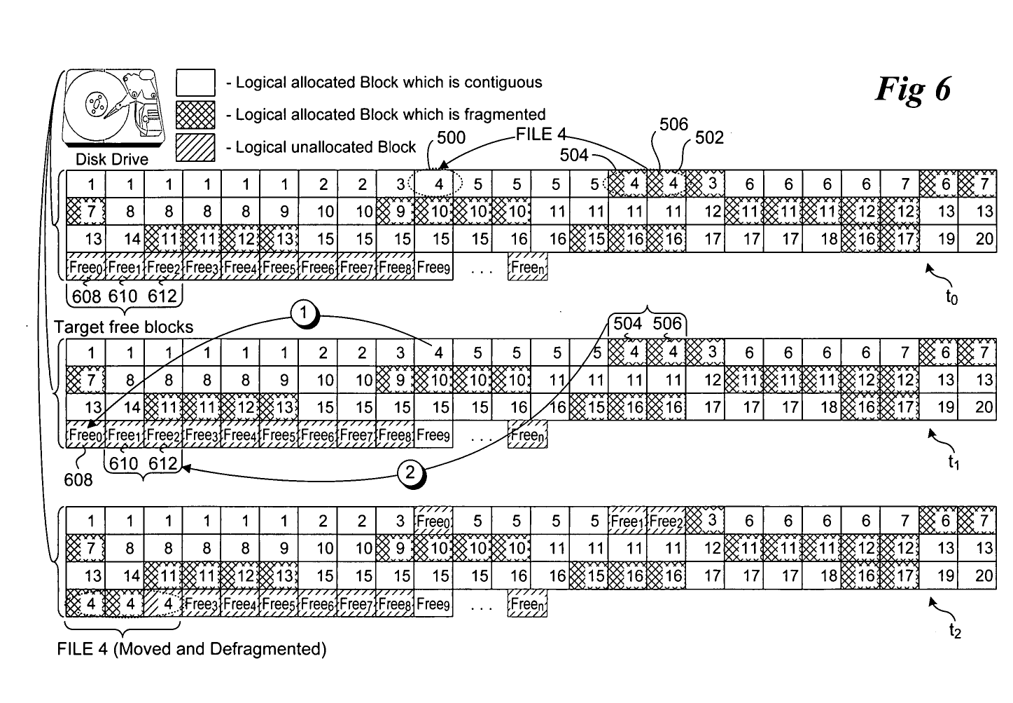

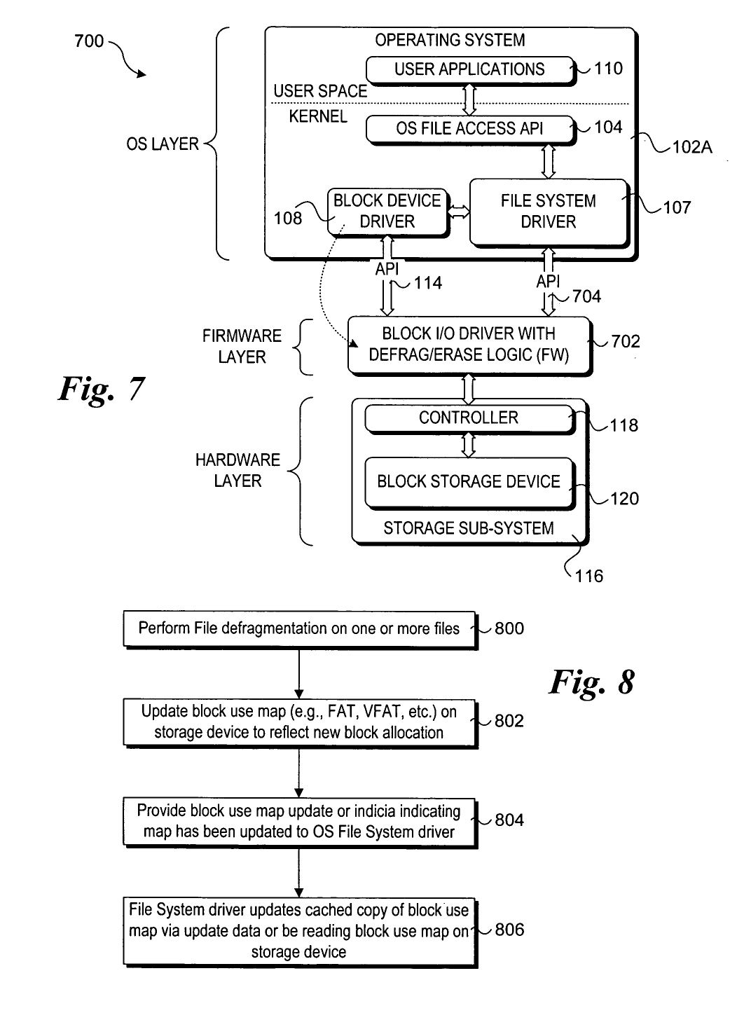

FIG. 7 shows a layered architecture 700 that employs the file defragmentation and erase logic in the firmware layer, rather than the OS layer. In further detail, the OS layer 102A includes the same components as OS layer 102 in FIG. 1, with the exception of file system driver 107, which replaces augmented file system driver 106 in FIG. 1. At the firmware layer, a firmware block I/O driver with defrag(mentation)/erase logic 702 is employed to facilitate both conventional firmware block I/O driver operations and the defragmentation and/or erase functions that are performed in a similar manner to that discussed above for augmented file system driver 106. In one embodiment, layered architecture 700 further includes an API 704 that is used to enable communication between file system driver 107 and firmware block I/O driver with defrag/erase logic 702, as described below.

In general, firmware block I/O driver with defrag/erase logic 702 performs file defragmentation and erase operations in conjunction with corresponding block I/O driver operations. For example, at the firmware level, a block I/O driver may be provided with a request from the operating system to write data to one or more blocks. Unlike a conventional firmware block I/O driver, however, firmware block I/O driver with defrag/erase logic 702 includes logic for performing the aforementioned file defragmentation and erase block storage device management operations. This logic includes the ability to perform defragmentation and erase operations in conjunction with conventional block I/O access request. For example, in response to a block write request, firmware block I/O driver with defrag/erase logic 702 may determine that the block (or blocks) belong to a fragmented file. Accordingly, firmware block I/O driver with defrag/erase logic 702 may perform file defragmentation operations in connection with performing the requested block write operation.

In one embodiment, the operations depicted as being performed by block device driver 108 may be performed by firmware block I/O driver with defrag/erase logic 702. In this case, the block I/O access requests provided to firmware block I/O driver with defrag/erase logic 702 will generally be at a higher level, since they are provided by file system driver 107. This may support tighter integration between the OS layer file system driver component and the corresponding firmware layer device driver component. In some implementations, the level of file system management performed by the OS layer file system driver component may be simplified by offloading these activities to firmware block I/O driver with defrag/erase logic 702. For example, in one embodiment file system driver 107 only needs to keep track of the starting block for each file, and an access (e.g., read, write, etc.) to a particular file is performed by simply referencing the starting block. The block usage aspects of the file system are managed by firmware block I/O driver with defrag/erase logic 702. Thus, in response to an access request, firmware block I/O driver with defrag/erase logic 702 will determine the appropriate blocks to modify.

Some operating systems maintain a cached copy of their block use map in memory. For example, a file system that employs a FAT-based scheme may maintain a cached version of the FAT in memory. This enhances disk access, since it is not necessary to read the FAT from the disk for each disk access operation. However, this creates a problem with regard to block storage device management operations (such as moving data between blocks to perform defragmentation) that are performed by non-OS entities. For instance, suppose that firmware block I/O driver with defrag/erase logic 702 defragments a file. In conjunction with this operation, the block use map on the disk is updated. Under an OS-controlled disk management scheme, such as presented above, the OS would both update the block use map on the disk and update its cached version of the map. Accordingly, there needs to be a mechanism for updating the cached version of the block use map when a non-OS entity performs disk management, thus maintaining synchrony between the cached block use map and the block use map stored on the disk.

One embodiment of a scheme for maintaining such synchrony is shown in FIG. 8. The process begins by performing file defragmentation on one or more files in a block 800. In connection with these operations, the block use map on the storage device (e.g., disk drive) is updated in a block 802 to reflect the new block allocation. Next, in a block 804, either an update of the entire block use map, an incremental update of the map, or indicia indicating the map is changed is provided to the OS file system driver. In the illustrated embodiment of FIG. 7, this may be performed via API 704, with data being provided from firmware block I/O driver with defrag/erase logic 702 to file system driver 107.

The process is completed in a block 806, wherein the files system drive updates its cached copy of the block use map. In one embodiment, this update may be performed by using the entire or incremental update of the block use map provided by firmware block I/O driver with defrag/erase logic 702. In the embodiment in which indicia indicating a change in the block use map has occurred, file system driver 107 performs the update by reading the block use map on the block storage device.

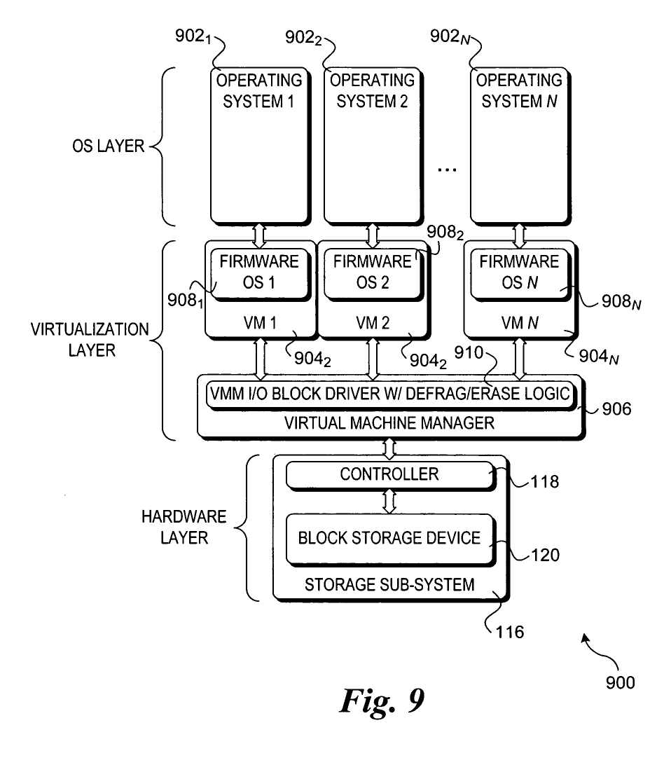

A layered architecture 900 that employs a virtual machine management (VMM) component to perform ongoing disk management operations is shown in FIG. 9. The VMM component is generally associated with operations performed by a virtual machine (VM), which is a software- or firmware-based construct that is functionally equivalent to physical hardware, at least from the perspective of its ability to execute software. A VM has the same features as a physical system: expansion slots, network interfaces, disk drives, and even firmware. Thus, a VM appears to an operating system as a physical machine. However, the VM, in practice, provides a level of abstraction between the OS and the underlying hardware.

Layered architecture 900 includes an OS layer over a virtualization layer over a hardware layer. The OS layer includes N operating systems 902_{1-N}, which may comprise different operating systems, multiple instances of the same operating system, or a combination of the two. The virtualization layer includes N virtual machines 904_{1-N} (one for each respective OS 902_{1-N}), and a virtual machine manager 906. The hardware layer includes the same components as shown in FIGS. 1 and 7 and discussed above.

In the illustrated embodiment, a firmware component associated with a corresponding OS instance is provided to support the functionality of each of virtual machines 904_{1-N}, as depicted by firmware components 908_{1-N}. In another embodiment (not shown) a firmware layer sits between the virtualization layer and the hardware layer. In different embodiments, the virtual machines ⁹⁰⁴1-N and/or virtual machine manager 906 may comprise software components (e.g., as part of a virtualization operating system), firmware components, or a combination of the two.

The file defragmentation and erase operations are performed by a VMM block I/O driver 910, which includes appropriate file defragmentation and erase logic to perform corresponding operations described herein. In addition to the configuration shown in FIG. 9, a similar VMM driver component may be implemented as a “shim” that is generally disposed somewhere between the VMs and the hardware layer.

Operations and logic for performing disk management using layered architecture 900 are shown in the flowchart of FIG. 2a. In general, blocks sharing the same reference numbers in FIGS. 2 and 2a perform similar operations. Accordingly, the differences between the flowcharts of FIGS. 2 and 2a are the focus of the following discussion.

Referring to FIG. 2a, the process begins as before in response to a power-on or reset event depicted by block 200, with basic platform initialization operations being performed in block 202. Included during platform initialization is the initialization of VMM 906, as well as the associated virtual management components. An operating system is then initialized in a block 206. (It is noted that operating systems may be started and stopped in an asynchronous manner during ongoing platform operations). During the ongoing run-time platform operations, it is presumed that multiple operating systems are currently active.

The event detection loop that triggers the disk management process is depicted by a decision block 209 in which a VMM trap occurs in response to an LBA I/O access event. This trapping is performed by VMM block I/O driver 910. In response, the logic proceeds to decision block 210 to determine whether defragmentation is enabled. If so, the logic proceeds to a decision block 218 in which a determination is made to whether the file system of the target (I/O transaction) has been determined. For example, in situations under which a single operating system is operating on a platform, the file system will be known based on the operating system. In situations under which multiple operating systems are concurrently running on respective VMs, the particular file system for a current I/O transaction may yet to be determined upon encountering decision block 218. Thus, the operation of block 220 will be performed to determine the file system of the target.

In one embodiment, the file system may be determined by probing the disk partition's OS indicator using the physical sector of the I/O transaction. For example, an exemplary master boot record partition table for a given block I/O device is shown in FIG. 10. The particular partition, and hence file system for a current I/O transaction may be determined by performing a lookup of the master boot record partition table using the sector of the LBA referenced by the I/O transaction. Once the file system of the target transaction is determined, the process proceeds to decision block 222, with the operations performed in this and other blocks being similar to those described above.

The net result of the foregoing VMM implementation of is that the VMM block I/O driver 910 performs “behind the scenes” disk management operations in a manner that is transparent to one or more operating systems, each running on the virtualization layer and hosted by a respective virtual machine. Generally, the VMM block I/O driver 910 may provide the layer of abstraction between a given OS file system and the underlying hardware, or such abstraction may be provided by the firmware instance employed for the VM hosting a given operating system.

In some embodiments, it may be necessary to provide updates to an operating system to ensure synchronization for cached block use maps with corresponding block use maps stored on an applicable storage device. In these situations, a scheme similar to that shown in FIG. 7 and described above may be employed.

In accordance with further aspects of some embodiments, the ongoing block storage device management operations may be performed by an embedded software or firmware component (e.g., agent or embedded application) running on one or more cores in a multi-core processor. The embedded agent or application functions as a file system accelerator, enabling a bulk of block I/O transaction operations to be off-loaded from the processor's main core or cores.

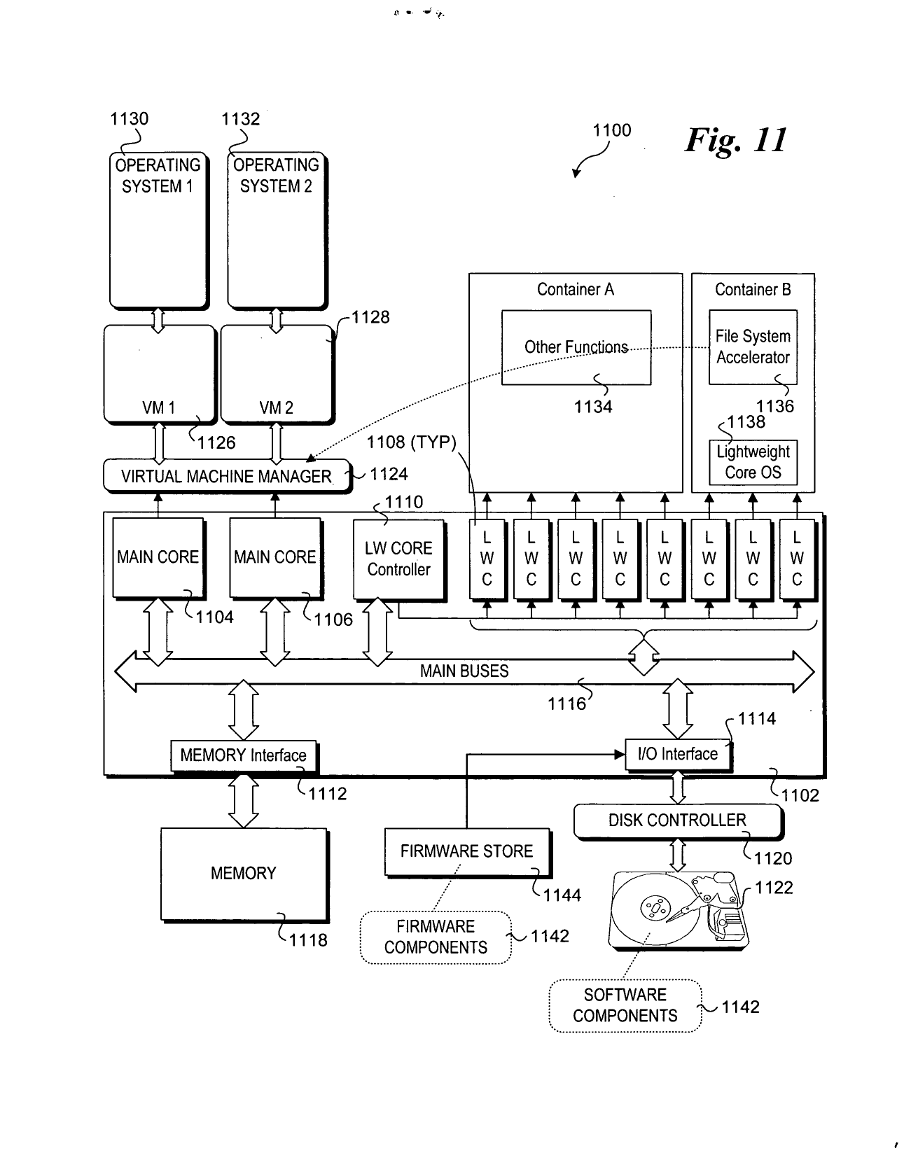

An exemplary implementation of such a scheme is depicted as a system 1100 in FIG. 11. Processing operations for system 1100 are performed by various cores in a multi-core processor 1102. Multi-core processors are envisioned as the next frontier in processor architecture, enabling performance to be scaled by employing multiple cores (i.e., processing engines similar to the core processing elements of today's single-core processors) rather than merely increasing bandwidth. Multi-core processor 1102 is illustrative of one type of multi-core architecture that includes one or more primary or main cores, and multiple secondary or auxiliary cores. As depicted in FIG. 11, multi-core processor 1102 includes two main cores 1104 and 1106 and eight “lightweight” (LW) cores 1108 (i.e., secondary cores). Other components of multi-core processor 1102 depicted in FIG. 11 include a lightweight core controller 1110, a memory interface 1112, and a I/O interface 1114, which are coupled to the main cores and lightweight cores by various address and data buses, which are collectively depicted as main buses 1116 for simplicity.

Memory interface 1112 is used to provide an interface between volatile memory devices (depicted as memory 1118) and multi-core processor 1102. In an alternative embodiment, the memory interface function depicted by memory interface 1112 may be provided by an off-chip component, such as that employed by a memory controller hub that is commonly employed in today's ubiquitous “North” bridge—“South” bridge chipset architectures. Similarly, the functions performed by I/O interface 1114 may be provided by an off-chip component, such as the I/O controller hub (ICH, i.e., South bridge) in a North-South bridge architecture. As yet another option, the functionality for memory interface 1112 and I/O interface 1114 may be provided by a single off-chip component.

I/O interface 1114 is used to support I/O transactions with various I/O devices. These typically include add-on peripheral cards, on-board PCI (peripheral component interconnect) devices, and block storage device controllers. An exemplary block storage device controller and corresponding block storage device in depicted in FIG. 11 by a disk controller 1120 and a magnetic disk drive 1122. In typical implementations, a disk controller may be implemented as an on-(mother)board device, such as the ICH for a chipset component, of may be implemented via an add-on peripheral card, such as for a SCSI controller or the like.

An exemplary software/firmware architecture is depicted for system 1110 that includes a virtual manage manager 1124, virtual machines 1126 and 1128, and operating systems 1130 and 1132. Each of operating systems 1130 generally includes the kernel components found in a conventional operating system, including applicable file system components. However, the file system components may be augmented to support either a virtual machine implementation and/or implementations that off-load block storage device I/O operations in the manner described herein and illustrated in FIG. 11.

The various lightweight cores 1108 may be typically employed to perform one or more dedicated tasks similar to that performed by an embedded processor or microcontroller under a conventional architecture. From a logical viewpoint, the embedded tasks are considered part of a corresponding container, as depicted by Container A and Container B in FIG. 11. The task depicted for Container A include other functions 1134, which represent various embedded functions that may be performed by the group of lightweight cores 1108 associated with Container A. Meanwhile, Container B supports a file system accelerator 1136, which functions as an embedded agent or application that provides file system and block storage device management operations in accordance with the embodiments discussed above.

Container B also includes a lightweight core operating system 1138. This operating system functions as an embedded OS that supports the various agents and applications hosted by the lightweight cores 1108, including agents and applications associated with other containers (e.g., Container A). The operations of lightweight core OS 1138, as well as the operations for file system accelerator 1136, are transparent to each of operating systems 1130 and 1132.

In general, the operations performed by virtual machine manager 1124, virtual machines 1126 and 1128, and the various embedded agents and applications may be provided by corresponding software and/or firmware components. The software components 1140 may typically reside on magnetic disk drive 1122, or be downloaded (all or in part) from a network store via a network interface coupled to I/O interface 1114 (both not shown). The firmware components 1142 for the system are stored in a firmware store 1144, which may typically comprises one of various well-known non-volatile memory devices, such as a flash memory device, EEPROM, ROM, etc. In FIG. 11, firmware store 1144 is depicted as being coupled to I/O interface 1114. However, this is merely one of many schemes via which firmware store 1144 may be operatively coupled to multi-core processor 1102.

During initialization of system 1100, appropriate firmware components are loaded from firmware store 1144 and executed on one or more of the cores to set-up the system for ongoing operations. In embodiments under which virtual machine manager 1124 and/or file system accelerator 1136 comprise firmware components, these components are configured and initialize prior to booting operating systems 1130 and 1132. In this case, lightweight core OS 1138 will also comprise a firmware component, and will be initialized during this phase.

In some embodiments, virtual machine manager 1124 and/or file system accelerator 1138 will comprise a portion of software components 1140. Accordingly, these components will be loaded from magnetic disk drive 1122 following the foregoing firmware initialization phase or in conjunction with the firmware initialization phase. Henceforth, the virtual machines 1126 and 1128 will be initialized, enabling operating systems 1130 and 1132 to be booted.

During ongoing (e.g., OS run-time) operations, the file systems of operating systems 1130 and 1132 will issue disk I/O transaction requests to virtual machines 1126 and 1128 (respectively), which will, in turn, be passed to virtual machine manager 1124. The disk I/O transactions requests will be intercepted by file system accelerator 1136, which logically resides in the virtualization layer in a manner similar to that described above for VMM I/O block driver 910 in FIG. 9. The disk I/O transaction will then be performed by file system accelerator 1136, thus off-loading this task from either of main cores 1104 and 1106, which are used to perform general-purpose processing operations for system 1100. Applicable disk management operations, including file defragmentation and file erasure operations, are performed by file system accelerator 1136, with appropriate I/O transaction data (e.g., write/erase transaction completed successfully, file read data, etc.) being returned to the operating system that made the corresponding request.

As described above, the ongoing block storage device management operations may be performed via execution of software, firmware, or a combination of the two. Thus, embodiments of this invention may be used as or to support software/firmware components executed upon some form of processing core or cores or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
performing ongoing block storage device management operations in conjunction with corresponding block storage device input/output (I/O) transactions.

2. The method of claim 1, wherein the ongoing block storage device management operations include performing ongoing file defragmentation operations.

3. The method of claim 2, further comprising:
detecting a block storage device I/O transaction request; and in response thereto,
performing file defragmentation of a file for which the block storage device I/O transaction pertains in conjunction with performing the device I/O transaction that was requested, wherein the file, upon defragmentation, is stored in a contiguous set of blocks.

4. The method of claim 3, further comprising:
performing the file defragmentation using a firmware-based component in a manner transparent to an operating system running on a machine used to access the block storage device.

5. The method of claim 4, wherein the operating system maintains a non-volatile block use map that maps the location of blocks used to store corresponding files in a file system hosted by the operating system and a cached version of the block use map in memory, the method further comprising:
performing a file defragmentation operation via the firmware-based component;
updating the non-volatile block use map to reflect changes to the block use map in view of the file defragmentation operation via the firmware-based component; and
providing block use map change information to the operating system that reflects the changes to the non-volatile block use map; and
updating the cached version of the block use map with the block use map change information.

6. The method of claim 2, further comprising:
performing a file defragmentation operation in a manner that maintains a location of a first block for a file that is defragmented.

7. The method of claim 1, further comprising:
employing a virtual machine manager component to perform the block storage device file management operations.

8. The method of claim 1, further comprising:
employing at least one core in a multi-core processor to perform the ongoing block storage device file management operations as an embedded operation.

9. The method of claim 1, wherein the block storage device comprises a magnetic disk drive.

10. The method of claim 1, wherein the ongoing block storage device management operations include performing ongoing file erase operations in conjunction with performing corresponding file deletions made in response to file deletion I/O transactions request issued by a file system.

11. The method of claim 10, wherein the file erase operations comprising writing over blocks used to store a given file before the file was deleted multiple times using an alternating pattern in a manner compliant with a National Security Association (NSA) standard for file erasure.

12. A machine-readable medium, to store instructions that if executed perform operations comprising:
detecting a block storage device input/output (I/O) transaction request; and
performing a block storage device management operation in conjunction with servicing the block storage device I/O transaction.

13. The machine-readable medium of claim 12, wherein the instructions comprise firmware instructions.

14. The machine-readable medium of claim 12, wherein block storage device management operation comprises performing a file defragmentation operation to defragment a file corresponding to the block storage device I/O transaction request.

15. The machine-readable medium of claim 12, wherein the block storage device management operation comprises performing a file erase operation to erase data artifacts in blocks used to store a file corresponding to the block storage device 1/O transaction request.

16. The machine-readable medium of claim 12, wherein the instructions are embodied in an operating system files system driver.

17. A system, comprising:
a multi-core processor, including at least one main core and a plurality of secondary cores;
a memory interface, either built into the multi-core processor or communicatively coupled thereto;
memory, coupled to the memory interface an input/output (I/O) interface, either built into the multi-core processor or communicatively coupled thereto;
a disk controller, coupled to the I/O interface;
a magnetic disk drive, coupled to the disk controller; and
a firmware store, operatively coupled to the multi-core processor, having instructions stored therein, which if executed on at least one of the plurality of secondary cores performs ongoing disk management operations in conjunction with corresponding I/O transactions performed to access data stored on the magnetic disk drive.

18. The system of claim 17, wherein the disk management operations comprise performing file defragmentation operations to defragment files referenced by corresponding I/O transaction requests.

19. The system of claim 17, wherein the disk management operations comprise performing file erasure operations to erase data artifacts stored in one or more blocks, for each file to be erased, on the magnetic disk drive in conjunction with performing file deletion operations in response to corresponding I/O transaction requests.

20. The system of claim 17, wherein execution of the firmware instructions further supports operations of a virtual machine manager that is used to manage a plurality of virtual machines, each virtual machine used to host a respective operating system.
